(19) United States
(12) Patent Application Publication
(10) Pub. No.: US 2006/0267986 A1
(43) Pub. Date: Nov. 30, 2006

(54) Method and apparatus for transmitting and receiving partial font file

(75) Inventors: Soo-kang Bae, Seongnam-si (KR); Jung-min Kang, Seoul (KR); Jin-yong Ahn, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/391,263

(22) Filed: Mar. 29, 2006

Related U.S. Application Data
(60) Provisional application No. 60/685,411, filed on May 31, 2005.

(30) Foreign Application Priority Data
Jul. 2, 2005 (KR) 10-2005-0059487

(51) Int. Cl. G06T 11/00

(52) U.S. Cl. 345/467

(57) ABSTRACT

A method and apparatus for transmitting and receiving a partial font file are provided. A partial font file transmitter included in the partial font file transceiving apparatus includes a storage unit for storing at least one font file for rendering characters, and a partial font file producing unit for extracting character information from received broadcasting application contents and transforming the font file stored in the storage unit on the basis of the extracted character information into a partial font file. Accordingly, a partial font file corresponding to the character information included in the broadcasting application contents is produced and used in data broadcasting environment, so that relatively rapid data transmission is possible and the usability of a bandwidth increases.

### CROSS-REFERENCE TO RELATED PATENT APPLICATIONS

This application claims priority from Korean Patent Application No. 10-2005-0059487, filed on Jul. 2, 2005, in the Korean Intellectual Property Office, and the benefit of U.S. Provisional Patent Application No. 60/685,411, filed on May 31, 2005, in the U.S. Patent and Trademark Office, the disclosures of which are incorporated herein in its entirety by reference.

### BACKGROUND OF THE INVENTION

1. Field of the Invention

The present invention relates to a method and apparatus for transmitting and receiving a partial font file, and more particularly, to a method and apparatus for transmitting and receiving a partial font file, by which characters are printed in a font corresponding to a partial font file produced using only rendering information of the characters corresponding to a code value of the characters extracted from a font file during data broadcasting, the characters being included in application contents.

2. Description of the Related Art

Digital broadcasting, such as, high-definition television (HDTV) broadcasting or digital multimedia broadcasting (DMB), has various advantages, such as mobility or an improvement in the quality of sounds and images, compared to analog broadcasting. Hence, techniques associated with current digital broadcasting are being rapidly developed and commonly used.

As the type of broadcasting changes from analog broadcasting to digital broadcasting as described above, not only audio/video data but also application information, which is provided through a data channel or a data section, is included in the data that a broadcaster sends to a user's terminal. Although an application generally determines a font type in which text information is to be displayed to a user, all receivers are not deemed to have the font determined by the application. Accordingly, many data broadcasting middleware standards, for example, an open cable application platform (OCAP), a DMB, or a multimedia home platform (MHP), support downloadable font files. In a data broadcasting system, a font file is transmitted from a transmitter to a receiver and used in the receiver. Generally, the transmitter puts font files on a carousel, and the receiver downloads the font files existing on the carousel in a storage unit or mounts the font files thereon. Such font files are used in displaying characters in a designated font to a user through an output device when the display is needed while performing a built-in program or a downloaded application program in the receiver.

A service bandwidth depends upon a transmission method between the transmitter and the receiver in the data broadcasting system. When the service bandwidth is sufficient, the capacity of a font file transmitted to the receiver does not matter too much. However, when a sufficient bandwidth is not allocated upon data transmission as in the DMB or DXB (Digital X Broadcasting), it is difficult to transmit a large capacity of font files to provide an application or a service. DXB denotes a method in which communications companies, such as, Vodafone, Sony, Siemens, T-Mobile, etc., harmonize mobile broadcasting standards, DVB-H and DAB (including T-DMB) with an European digital broadcasting standard, DVB-T. The transmission of the large-capacity font file causes time delay and bandwidth waste.

When a True Type font is used, rendering information is often formed in a vector method. More specifically, a single Korean alphabet (i.e., Hangeul) font file has a size of several megabytes to several tens of megabytes, which is larger than an English alphabet font file.

### SUMMARY OF THE INVENTION

The present invention provides a method and apparatus for transmitting and receiving a partial font file produced using only code values of characters to be used in an application upon data broadcasting.

According to an aspect of the present invention, there is provided a partial font file transmitter including a storage unit for storing at least one font file for rendering characters and a partial font file producing unit for extracting character information from received broadcasting application contents and transforming the font file stored in the storage unit on the basis of the extracted character information into a partial font file.

According to another aspect of the present invention, there is provided a partial font file transmitting method including the operations of: extracting character information from received broadcasting application contents; producing a partial font file by changing a font file for rendering characters on the basis of the extracted character information; and transmitting the partial font file.

According to another aspect of the present invention, there is provided a partial font file receiver including a receiving unit which receives broadcasting application contents to be displayed and a partial font file including rendering information of character information included in the broadcasting application contents, a storage unit which stores the partial font file, and a font engine unit which downloads rendering information corresponding to the character information among the rendering information included in the partial font file from the storage unit. The partial font file is produced by changing a font file for rendering characters.

According to another aspect of the present invention, there is provided a partial font file receiving method comprising the operations of: receiving broadcasting application contents to be displayed and a partial font file including rendering information of character information included in the broadcasting application contents; storing the partial font file; and downloading rendering information corresponding to the character information among the rendering information included in the partial font file from the storage unit. In this method, the partial font file is produced by changing a font file for rendering characters.

According to another aspect of the present invention, there is provided a computer readable recording medium which stores a computer program for executing the partial font file transmitting method.

According to another aspect of the present invention, there is provided a computer readable recording medium which stores a computer program for executing the partial font file receiving method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a partial font file transmitter according to an exemplary embodiment of the present invention;

FIGS. 2A through 2C illustrate examples of a font file format stored in a storage unit of FIG. 1;

FIGS. 3A through 3C illustrate examples of a partial font file format produced by a partial font file producing unit of FIG. 1;

FIG. 4 is a block diagram of a partial font file receiver according to an exemplary embodiment of the present invention;

FIG. 5 is a flowchart illustrating a partial font file transmitting method according to an exemplary embodiment of the present invention;

FIG. 6 is a flowchart illustrating a partial font file receiving method according to an exemplary embodiment of the present invention; and

FIG. 7 is a flowchart illustrating a method of displaying characters in a font indicated by a partial font file received in FIG. 6.

### DETAILED DESCRIPTION OF THE INVENTION

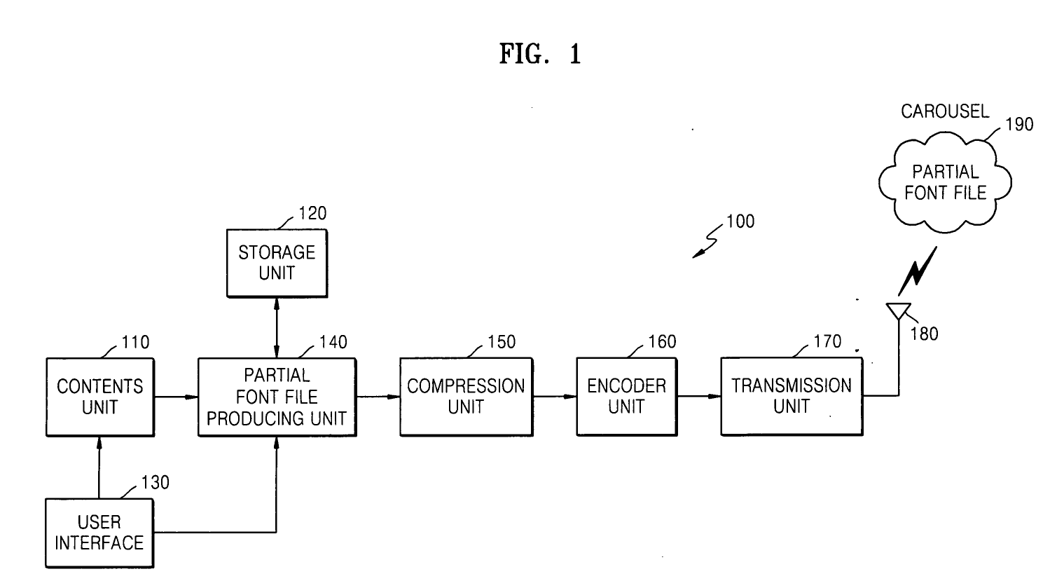

FIG. 1 is a block diagram of a partial font file transmitter 100 according to an exemplary embodiment of the present invention. Referring to FIG. 1, the partial font file transmitter 100 includes a contents unit 110, a storage unit 120, a user interface 130, a partial font file producing unit 140, a compression unit 150, an encoder unit 160, a transmission unit 170, and an antenna 180. The partial font file transmitter 100 transmits a partial font file via the antenna 180 to a carousel 190 located at an imaginary space.

The contents unit 110 supplies broadcasting application contents. The broadcasting application contents denote contents that are supplied in addition to broadcasting audio/video (AV) data using a data channel or a data section to provide a broadcasting application service. In other words, the broadcasting application contents do not denote broadcasting AV data shown in actual DMB broadcasting but contents associated with a broadcasting application. The partial font file transmitter 100 produces a partial font file and transmits the same, so the broadcasting application contents include characters.

More specifically, if a quiz program runs in actual DMB broadcasting, the broadcasting application contents may be quiz program application contents displayed on a predetermined area of a screen to help a viewer to participate in the quiz program. The quiz program application contents include characters, and the characters are displayed on the screen so that the viewer can see the characters.

The storage unit 120 stores a plurality of font files that help characters to be printed in a plurality of fonts. For example, the font files stored in the storage unit 120 may be associated with a Ming-style printing type, a Gothic printing type, a Batang printing type, a Gulim printing type, etc. Each of the font files includes rendering information about all of the characters belonging to a specific character set.

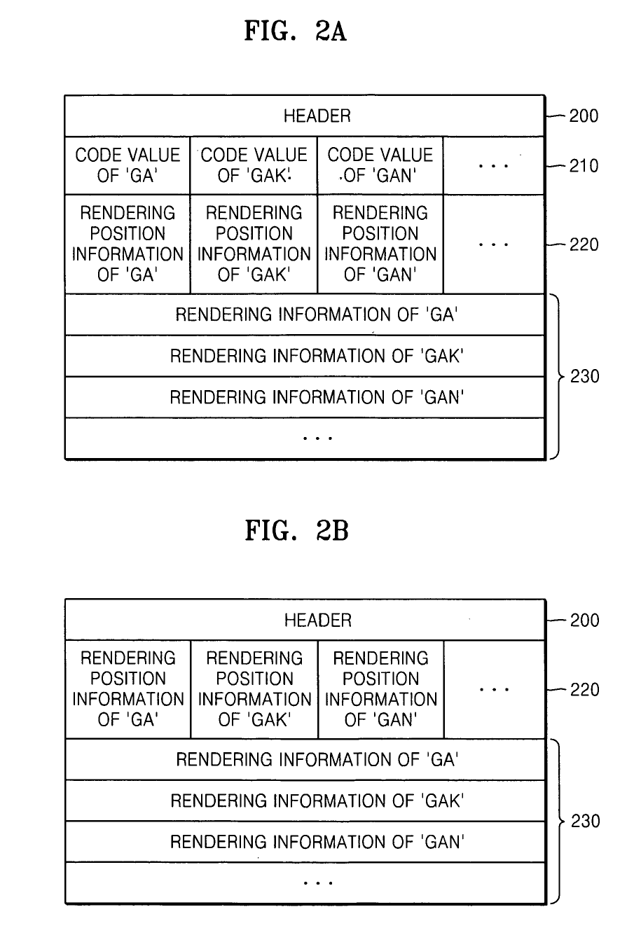

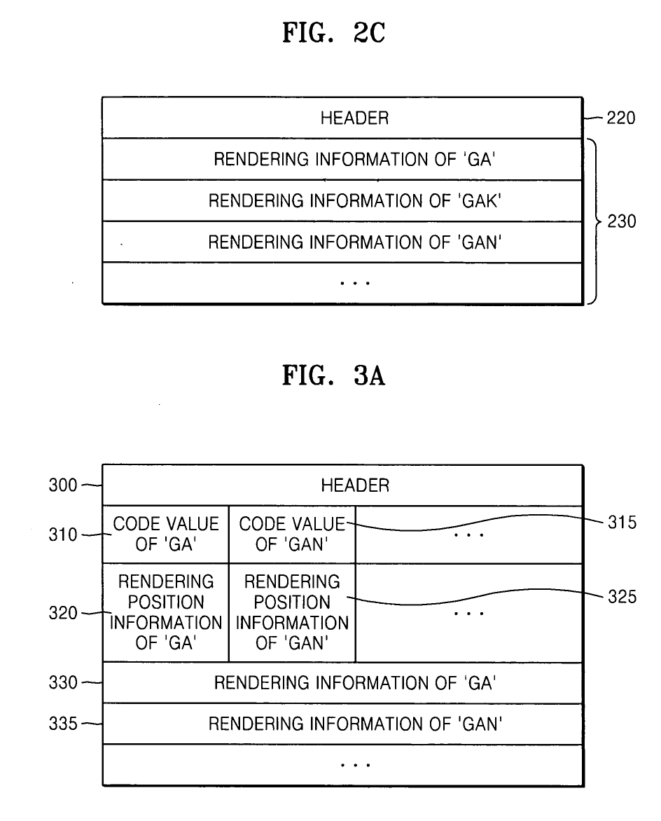

Each of the font files stored in the storage unit 120 has one format of a first format that includes code values of characters and rendering information and rending position information about the characters, a second format that includes rendering information and rending position information about characters, and a third format that includes rendering information about characters. The first, second, and third format are illustrated in FIGS. 2A, 2B, and 2C, respectively, and described in greater detail later.

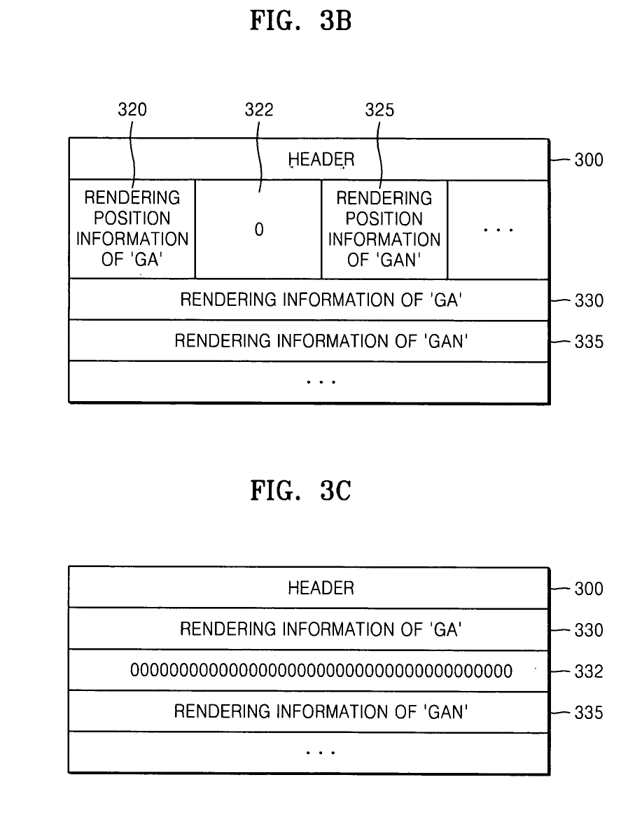

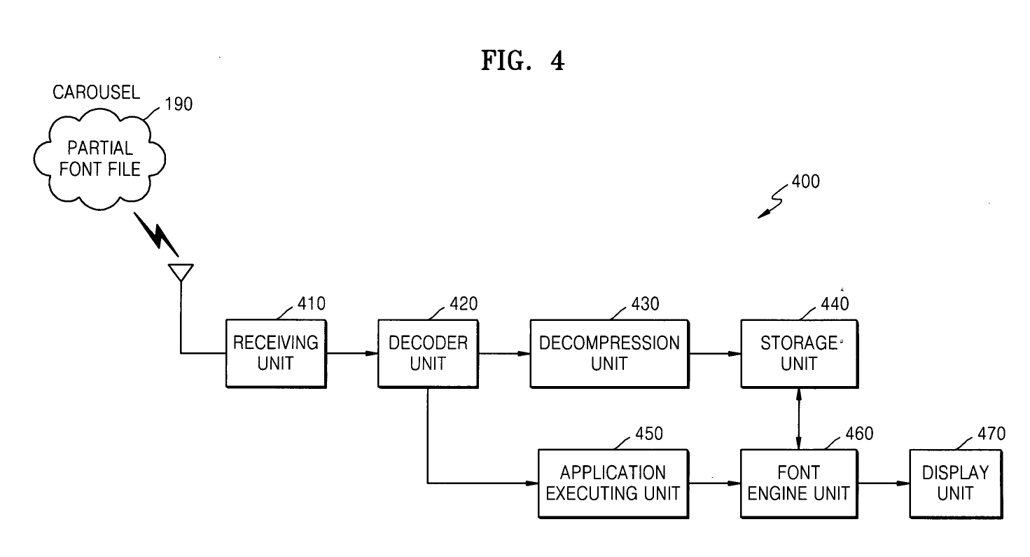

The user interface 130 receives a command from a user to control the contents unit 110 and the partial font file producing unit 140. User interface 130 also receives font file setting information from an input/output interface, indicating fonts determined as printing types for corresponding characters, and provides the received command and information to the contents unit 110 and/or the partial font file producing unit 140. The partial font file producing unit 140 extracts character information from the broadcasting application contents received from the contents unit 110 and downloads from the storage unit 120 a font file corresponding to a font set as a printing type in which the extracted character information is to be printed, thereby producing a partial font file. For example, “This broadcasting program is a quiz program, so viewers, please participate in this quiz program.” is extracted as the extracted character information, and the font in which the extracted character information is to be printed is a Gothic printing type. The operation of the partial font file producing unit 140 will be described in greater detail later with reference to FIGS. 3A through 3C.

The compression unit 150 receives the partial font file from the partial font file producing unit 140 and compresses the same. The compression unit 150 may be implemented as various compression algorithms.

The encoder unit 160 receives the compressed partial font file from the compression unit 150 and encodes the same into a transmission stream. Also, the encoder unit 160 performs encoding according to an MPEG encoding method or other methods.

The transmission unit 170 transmits the encoded transmission stream via the antenna 180 to the carousel 190 according to a digital broadcasting standard or other transmission standards. The transmission unit 170 may also transmit various digital data associated with broadcasting services when transmitting the encoded transmission stream.

FIGS. 2A through 2C illustrate examples of a format of a font file stored in the storage unit 120 of FIG. 1. A font file of FIG. 2A includes a header 200, code values of characters 210, rendering information thereof 230, and rendering position information thereof 220. The characters are Korean characters, “Ga”, “Gak”, and “Gan”. The code values and rendering position information of the characters are mapped.

A font file of FIG. 2B includes a header 200, rendering information of characters 230, and rendering position information thereof 220. The characters are Korean characters, “Ga”, “Gak”, and “Gan”. Compared with FIG. 2A, the font file of FIG. 2B includes no code values of the characters. In other words, in the font file of FIG. 2B, code values of the characters are not mapped with the rendering position information of the characters. In this case, it is assumed that the code values of the characters are sequentially mapped with the position information.

A font file of FIG. 2C includes a header 200 and rendering information of characters 230. The characters are Korean characters, “Ga”, “Gak”, and “Gan”. In a font file format as shown in FIG. 2C, rendering information of characters are stored with fixed sizes in a sequence from the first character to the last character, according to a character encoding format and defined code values.

FIGS. 3A through 3C illustrate examples of a format of the partial font file produced by the partial font file producing unit 140 of FIG. 1. Referring to FIGS. 3A through 3C, the partial font file does not include the character “Gak” among the characters “Ga”, “Gak”, and “Gan” shown in FIGS. 2A through 2C. The format structures of FIGS. 3A, 3B, and 3C are the same as those of FIGS. 2A, 2B, and 2C, respectively.

The partial font file format of FIG. 3A only includes the header 300, the character “Ga” code value 310, the character “Ga” rendering position information 320, the character “Ga” rendering information 330, the character “Gan” code value 315, the character “Gan” rendering position information 325, and the character “Gan” rendering information 335 without the character “Gak” code value, the character “Gak” rendering position information, and the character “Gak” rendering information.

In the partial font file format of FIG. 3B, a field for the character “Gak” rendering position information is filled with a specific value 322, and the character “Gak” rendering information does not exist. In other words, the setting of a specific value (e.g., a logic value 0) as the character “Gak” rendering position information 322 indicates that no rendering information for the character “Gak” exists. In contrast with FIG. 3A, the code values of the characters are not mapped with the rendering position information thereof in the format of FIG. 3B, so that the rending position information of all of the characters are not removed.

In the partial font file format of FIG. 3C, a field for the character “Gak” rendering information 332 is filled with a specific value, that is, a logic value 0.

FIG. 4 is a block diagram of a partial font file receiver 400 according to an exemplary embodiment of the present invention. Referring to FIG. 4, the partial font file receiver 400 includes a receiving unit 410, a decoder unit 420, a decompression unit 430, a storage unit 440, an application executing unit 450, a font engine unit 460, and a display unit 470.

The receiving unit 410 receives the broadcasting application contents and the partial font file from the partial font filer transmitter 100 of FIG. 1. The received broadcasting application contents and the partial font file are in the form of transmission streams. The partial font file is received by the receiving unit 410 via the carousel 190 located in an imaginary space.

The decoder unit 420 performs decoding corresponding to an encoding standard used in the partial font file transmitter 100 of FIG. 1. For example, when encoding was performed according to the MPEG-2 standard, decoding is performed according to the MPEG-2 standard. Then, the decoder unit 420 outputs decoded broadcasting application contents to the application executing unit 450 and decoded partial font file to the decompression unit 430.

The decompression unit 430 determines whether the decoded partial font file received from the decoder unit 420 has been compressed, and performs decompression when it is determined that the decoded partial font file has been compressed. Here, the decompression unit 430 should have in advance a decompression algorithm compatible with a compression algorithm used in the compression unit 150 of the partial font file transmitter 100 of FIG. 1. Meanwhile, when it is determined that the decoded partial font file has not been compressed, the decompression unit 430 does not perform decompression.

The storage unit 440 receives and stores the partial font file decompressed by the decompression unit 430. When the decompression unit 430 does not perform decompression, the storage unit 440 receives the not-compressed, decoded partial font file from the decompression unit 430 and stores the same. If the storage unit 440 has already a decoded partial font file not decompressed by the decompression unit 430 or decompressed thereby when receiving the current partial font file decompressed or not decompressed by the decompression unit 430, the previous partial font file is updated with the current partial font file. The update of the previous partial font file denotes addition of some of the characters stored in the current partial font file not existing in the previous partial font file to the previous partial font file when the name of the current partial font file is the same as that of the previous partial font file, that is, when the name of the current partial font file is a Gothic printing type.

The application executing unit 450 determines whether to execute a broadcasting application by referring to the broadcasting application contents received from the decoder unit 420. If the broadcasting application contents meet a predetermined condition, the application executing unit 450 executes the broadcasting application. The application executing unit 450 extracts character information from the received broadcasting application contents and transmits the character information to the font engine unit 460.

The font engine unit 460 downloads rendering information corresponding to the extracted character information among the rendering information included in the partial font file from the storage unit 440 and outputs the rendering information to the display unit 470. The display unit 470 displays the character information in a font indicated by the rendering information received from the font engine unit 460.

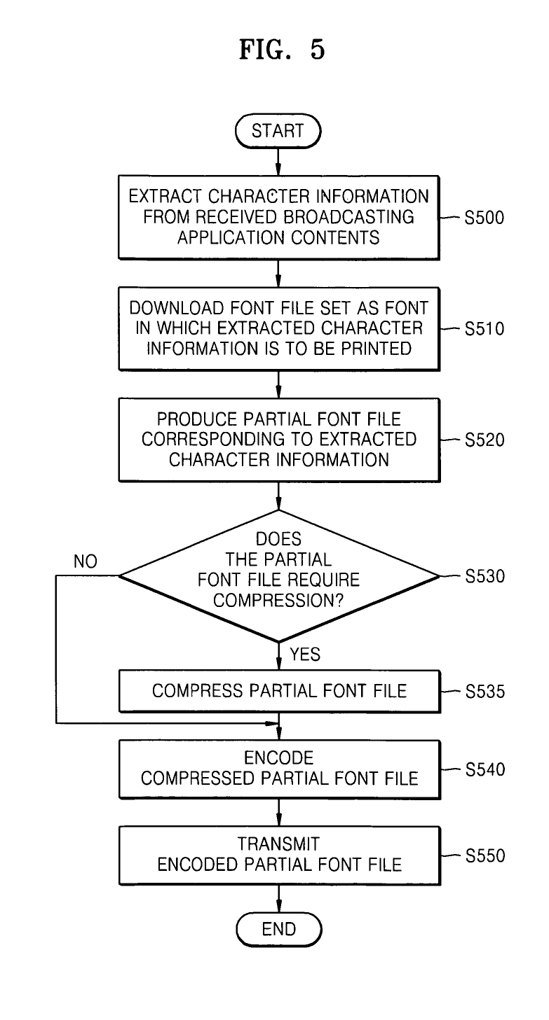

FIG. 5 is a flowchart illustrating a partial font file transmitting method according to an embodiment of the present invention. Referring to FIG. 5, in operation S500, character information is extracted from received broadcasting application contents.

Then, in operation S510, a font file set for the extracted character information is downloaded. Font files help characters to be printed in fonts. For example, the font files may be associated with a Ming-style printing type, a Gothic printing type, a Batang printing type, a Gulim printing type, etc. Each of the font files includes rendering information about all of the characters belonging to a specific character set.

Each of the font files has one format of a first format that includes code values of characters and rendering information and rending position information about the characters, a second format that includes rendering information and rending position information about characters, and a third format that includes rendering information about characters. The first, second, and third formats of the font files stored in the storage unit 120 are illustrated in FIGS. 2A, 2B, and 2C, respectively.

After operation S510, in operation S520, a partial font file corresponding to the extracted character information is produced from the downloaded font file. The production of the partial font file can be understood well by referring to FIGS. 3A through 3C.

In operation S530, it is determined whether the partial font file produced in operation S520 needs to be compressed. If not, operation S540 is performed. If compression is needed, the compression may be implemented according to various compression algorithms in operation S535, and is followed by operation S540.

In operation S540, the partial font file is encoded. The compressed partial font file is converted into a transmission stream through the encoding. The encoding may be performed according to an MPEG scheme or other methods.

Thereafter, in operation S550, the transmission stream produced in operation S540 is transmitted. The transmission of the transmission stream is performed according to the digital broadcasting standard or other transmission standards. More specifically, in operation S550, the transmission stream may be transmitted to the carousel. In operation S550, various digital data associated with a broadcasting application service may be transmitted together with the transmission stream. Items not described in FIG. 5 can be understood with reference to FIGS. 1 through 3C.

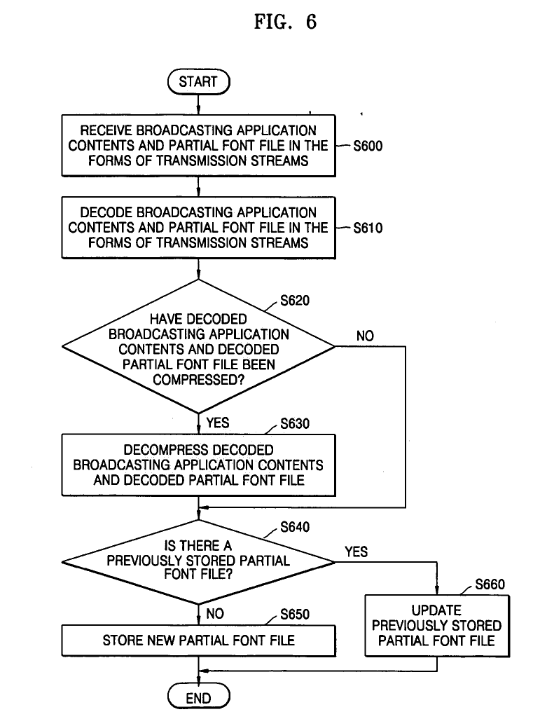

FIG. 6 is a flowchart illustrating a partial font file receiving method according to an embodiment of the present invention. Referring to FIG. 6, first, in operation S600, broadcasting application contents and a partial font file in the forms of transmission streams are received.

Then, in operation S610, the broadcasting application contents and the partial font file in the forms of transmission streams received in operation S600 are decoded. The decoding corresponds to an encoding standard used by a partial font file transmitter.

Thereafter, in operation S620, it is determined whether the broadcasting application contents and the partial font file decoded in operation S610 have been compressed.

If it is determined in operation S620 that the decoded broadcasting application contents and the decoded partial font file have been compressed, decompression is performed in operation S630, and followed by operation S640. On the other hand, if it is determined in operation S620 that the decoded broadcasting application contents and the decoded partial font file have not been compressed, operation S640 is performed.

In operation S640, it is determined whether a partial font file is previously stored. The determination may be made by determining whether the name of the current partial font file is the same as that of the previous partial font file. For example, when the current partial font file is associated with the Gothic printing type, the existence or nonexistence of the previous partial font file is determined by determining whether the previous partial font file is also associated with the Gothic printing type.

If it is determined in operation S640 that no previous partial font files are stored, the current partial font file is stored in operation S650. On the other hand, if it is determined in operation S640 that a partial font file is previously stored, the previous partial font file is updated with the current partial font file in operation S660. The update of the previous partial font file in operation S660 denotes addition of some of the characters stored in the current partial font file not existing in the previous partial font file to the previous partial font file when the name of the current partial font file is the same as that of the previous partial font file, that is, when the name of the current partial font file is the Gothic printing type.

Items not described in FIG. 6 can be understood with reference to FIGS. 1 through 4.

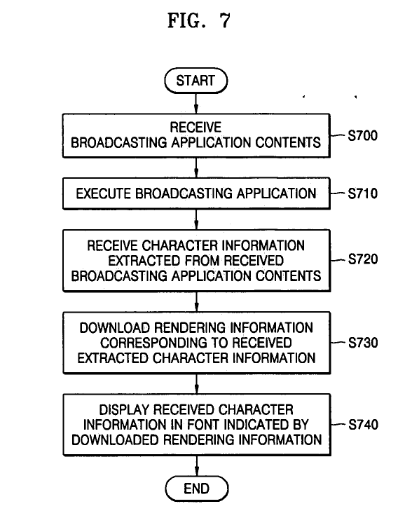

FIG. 7 is a flowchart illustrating a method of displaying characters in a font indicated by the received partial font file shown in FIG. 6. The method of FIG. 7 corresponds to a displaying method performed when a partial font file is previously stored as described above with reference to FIG. 6.

First, in operation S700, broadcasting application contents are received. The broadcasting application contents may be considered as the broadcasting application contents decoded in operation S610 of FIG. 6.

Then, in operation S710, a broadcasting application is executed. More specifically, in operation S710, it is determined whether to execute the broadcasting application by referring to the received broadcasting application contents, and the broadcasting application is executed if the broadcasting application contents meet a predetermined condition. For example, if data information or electron program guide (EPG) information is set to provide an application service for the quiz program, the broadcasting application is executed. Also, in operation S710, character information is extracted from the received broadcasting application contents.

Next, in operation S720, the character information extracted from the received broadcasting application contents is received. Then, in operation S730, rendering information corresponding to the extracted character information among the rendering information included in the previously stored partial font file (see FIG. 6) is downloaded.

Then, in operation S740, the character information received in operation S720 are displayed in a font indicated by the rendering information downloaded in operation S730.

Items not described in FIG. 7 can be understood with reference to FIGS. 1-4 and 6.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

In a method and apparatus for transmitting and receiving a partial font file according to the present invention, the use of a data broadcasting network bandwidth can be reduced. In cases of DMB or DXB having a channel whose bandwidth used to transmit pure data is not sufficient, a bandwidth used to transmit a font file can be reduced due to production of a partial font file. Accordingly, the time required to transmit the font file can be reduced.

Furthermore, for example, more data can be transmitted using a bandwidth saved due to the use of the partial font file. In other words, the usability of the bandwidth can increase.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A partial font file transmitter comprising:
a storage unit which stores at least one font file for rendering characters; and
a partial font file producing unit which extracts character information from received broadcasting application contents and transforms the font file stored in the storage unit into a partial font file on the basis of the extracted character information.

2. The partial font file transmitter of claim 1, wherein each of the font files has one format of a first format that includes code values of characters and rendering information and rendering position information about the characters, a second format that includes rendering information and rendering position information about characters, and a third format that includes rendering information about characters.

3. The partial font file transmitter of claim 2, wherein when the font file which is transformed on the basis of the extracted character information has the first format, the partial font file producing unit produces a partial font file using only a code value of the extracted character information, rendering information about the extracted character information, and rendering position information about the extracted character information extracted from the font file.

4. The partial font file transmitter of claim 2, wherein when the font file which is transformed on the basis of the extracted character information has the second format, the partial font file producing unit produces a partial font file by extracting rendering information about the extracted character information and rendering position information about the extracted character information from the font file and setting rendering position information about characters other than the extracted character information to be specific values.

5. The partial font file transmitter of claim 4, wherein the specific values are logic values of 0.

6. The partial font file transmitter of claim 2, wherein when the font file which is transformed on the basis of the extracted character information has the third format, the partial font file producing unit produces a partial font file by extracting only rendering information about the extracted character information from the font file and setting rendering information about characters other than the extracted character information to be specific values.

7. The partial font file transmitter of claim 6, wherein the specific values are logic values of 0.

8. The partial font file transmitter of claim 1, wherein the broadcasting application contents provide a broadcasting application service in addition to broadcasting audio/video data.

9. The partial font file transmitter of claim 1, further comprising a user interface which selects a font file corresponding to a font in which the extracted character information is to be displayed from the font files.

10. The partial font file transmitter of claim 1, further comprising a compression unit which compresses the partial font file.

11. The partial font file transmitter of claim 10, further comprising:
an encoder unit which encodes the compressed partial font file; and
a transmission unit which transmits the encoded partial font file.

12. The partial font file transmitter of claim 1, further comprising:
an encoder unit which encodes the produced partial font file; and
a transmission unit which transmits the encoded partial font file.

13. The partial font file transmitter of claim 12, wherein the transmission unit transmits the partial font file to a carousel.

14. A partial font file transmitting method comprising:
extracting character information from received broadcasting application contents;
producing a partial font file by changing a font file for rendering characters on the basis of the extracted character information; and
transmitting the partial font file.

15. The partial font file transmitting method of claim 14, wherein the font file has one format of a first format that includes code values of characters and rendering information and rendering position information about the characters, a second format that includes rendering information and rendering position information about characters, and a third format that includes rendering information about characters.

16. The partial font file transmitting method of claim 15, wherein in the producing of the partial font file, when the font file which is transformed on the basis of the extracted character information has the first format, the partial font file is produced using only a code value of the extracted character information, rendering information about the extracted character information, and rendering position information about the extracted character information extracted from the font file.

17. The partial font file transmitting method of claim 15, wherein in the producing of the partial font file, when the font file which is transformed on the basis of the extracted character information has the second format, the partial font file is produced by extracting rendering information about the extracted character information and rendering position information about the extracted character information from the font file and setting rendering position information about characters other than the extracted character information to be specific values.

18. The partial font file transmitting method of claim 15, wherein in the producing of the partial font file, when the font file which is transformed on the basis of the extracted character information has the third format, the partial font file is produced by extracting only rendering information about the extracted character information from the font file and setting rendering information about characters other than the extracted character information to be specific values.

19. The partial font file transmitting method of claim 14, wherein the broadcasting application contents provide a broadcasting application service in addition to broadcasting audio/video data.

20. The partial font file transmitting method of claim 14, between the producing of the partial font file and the transmitting of the partial font file, further comprising compressing the partial font file.

21. The partial font file transmitting method of claim 14, wherein in the transmitting of the partial font file, the partial font file is transmitted to a carousel.

22. A partial font file receiver comprising:
a receiving unit which receives broadcasting application contents to be displayed and a partial font file including rendering information of character information included in the broadcasting application contents;
a storage unit which stores the partial font file; and
a font engine unit which downloads rendering information corresponding to the character information among the rendering information included in the partial font file from the storage unit,
wherein the partial font file is produced by changing a font file for rendering characters.

23. The partial font file receiver of claim 22, further comprising a decompression unit which determines whether the received partial font file has been compressed, which decompresses the received partial font file if it is determined that the received partial font file has been compressed, and outputs the decompressed partial font file to the storage unit.

24. The partial font file receiver of claim 22, wherein the broadcasting application contents and the partial font file received by the receiving unit are in the form of transmission streams.

25. The partial font file receiver of claim 24, further comprising a decoder unit which receives the broadcasting application contents and the partial font file in the form of transmission streams from the receiving unit and decodes the broadcasting application contents and the partial font file.

26. The partial font file receiver of claim 22, further comprising an application execution unit which receives the decoded broadcasting application contents from the decoder unit, extracts character information from the received broadcasting application contents, and transmits the character information to the font engine unit if the broadcasting application contents meet a predetermined condition.

27. The partial font file receiver of claim 22, wherein the receiving unit receives the broadcasting application contents and the partial font file from a carousel.

28. The partial font file receiver of claim 22, wherein if a partial font file pre-exists in the storage unit, the storage unit updates character information included in the pre-existing partial font file.

29. A partial font file receiving method comprising:
receiving broadcasting application contents to be displayed and a partial font file including rendering information of character information included in the broadcasting application contents;
storing the partial font file; and
downloading rendering information corresponding to the character information among the rendering information included in the partial font file from the storage unit,
wherein the partial font file is produced by changing a font file for rendering characters.

30. The partial font file receiving method of claim 29, between the receiving of the broadcasting application contents and the partial font file and the storing of the partial font file, further comprising determining whether the received partial font file has been compressed and decompressing the received partial font file if it is determined that the received partial font file has been compressed.

31. The partial font file receiving method of claim 29, wherein the broadcasting application contents to be displayed and the partial font file including the rendering information about character information included in the broadcasting application are in the form of transmission streams.

32. The partial font file receiving method of claim 29, between the receiving of the broadcasting application contents and the partial font file and the storing of the partial font file, further comprising receiving and storing the broadcasting application contents to be displayed and the partial font file including the rendering information about character information included in the broadcasting application.

33. The partial font file receiving method of claim 29, wherein in the storing of the partial font file, if a partial font file has already been stored, character information included in the previously stored partial font file is updated.

34. A computer readable recording medium which stores a computer program for executing the partial font file transmitting method described in claim 14.

35. A computer readable recording medium which stores a computer program for executing the partial font file receiving method described in claim 29.
